(19) United States
(12) Patent Application Publication
(10) Pub. No.: US 2015/0244912 A1
(43) Pub. Date: Aug. 27, 2015

(54) CAMERA SYSTEM AND OPERATING METHOD THEREOF

(71) Applicant: Beseye Cloud Security Co., Ltd., Taipei City (TW)

(72) Inventors: TSE-MING CHANG, Taipei City (TW); HSUAN-FU HUANG, Taipei City (TW); CHENG-HAN TU, Taipei City (TW)

(73) Assignee: Beseye Cloud Security Co., Ltd., Taipei City (TW)

(21) Appl. No.: 14/262,696

(22) Filed: Apr. 25, 2014

(30) Foreign Application Priority Data
Feb. 27, 2014 (TW) 103106725

(51) Int. Cl. H04N 5/232

(52) U.S. Cl. CPC H04N 5/232; H04N 2101/00

(57) ABSTRACT

The present invention provides a camera system and the operating method thereof, wherein the camera system transmits a digital token via sound waves and uses the digital token for device pairing, authorizing, or authenticating. The camera system comprises a transmitting device, for converting the digital token to an acoustic signal, and a camera device, for converting the acoustic signal to the digital signal.

### BACKGROUND OF THE INVENTION

1. Technical Field

At least one embodiment provides a camera system and the operating method thereof. More particularly, at least one embodiment provides a camera system able to transmit a digital token via sound waves and the operating method thereof.

2. Description of the Related Art

Camera devices are well known in the art. Camera devices are one of the common appliances intensively used in residential or corporate environments including homes, businesses, offices, or public sections. Camera devices are able to capture real-time image, video, and audio data, and stream these data to remote users via Internet. Nowadays, camera devices are used, for example, to observe crime hotspots, monitor children or senior citizens, and establish video links such as videophone calls and videoconferencing.

Conventional camera devices, webcams and surveillance systems, rely on physical links such as USB cables, parallel cables, or composite AV cables to deliver the captured data to the linked displays; therefore, conventional camera devices are, due to the length and cost of the cable network, only able to be installed within a limited range close the linked displays. Recently, developments and expansions of wireless communication technologies had greatly changed the way people live. Camera devices are now capable of accessing Internet by the 3G, LTE, Wi-Fi, or Bluetooth networks. Wireless camera devices, those camera devices with wireless communication technologies, are free from physical links which restricts the installing region of camera devices.

However, wireless camera devices come with new problems not existing in conventional camera devices. Conventional camera devices required physical links to communicate with the linked displays; at the meantime, physical links play another role which directs the routes of data transmission. Nevertheless, wireless camera devices, lacking physical links, communicate with displays in the air. Two distinct scenarios of wireless camera devices are foreseen; in the first scenario, a wireless camera device lacking the ability to pair with another device may bring the user inconvenience; in the second scenario, a wireless camera device set to be opened and does not required any authentication to access may lead to privacy issues. Therefore, an additional procedure for assigning a target to a wireless camera device is needed. In society nowadays, one space usually contains multiple displays and multiple wireless camera devices, this situation especially emphasizes the importance of device pairing, authorizing, and authenticating.

Another challenge a wireless camera device may encounter is the difficulties in accessing wireless access points (AP). For example, several wireless APs may co-exist in a space; the wireless AP may require a password to access; and, the service set identification (SSID) of wireless AP may be hidden. Under the above circumstances, a wireless camera device may be refrained from fully functioning due to the reason that lacking a user interface or a input interface to input any required information to access a wireless AP.

### SUMMARY

Wireless camera devices come with several problems not existing in conventional camera devices. In one example, wireless camera devices face a challenge to determine a target to stream the data to without wires or cables connected in-between; in a further example, wireless camera devices have difficulties in accessing a network via a secured AP. Accordingly, there is a need for methods for device pairing, authorizing, or authenticating to overcome the above-mentioned problems. At least one embodiment in accordance with the present invention provides a camera system and the operating thereof, wherein the camera system is able to transmit a digital token via sound waves.

In some embodiments, a camera system comprises: a transmitting device and a camera device. The transmitting device, for example, contains a first processing unit adapted to convert a digital token to an acoustic signal and an acoustic wave generator adapted to transmit the acoustic signal, wherein the acoustic wave generator is connected to the first processing unit. The camera device, for example, contains an acoustic wave sensor adapted to sense an acoustic signal and a second processing unit adapted to convert the acoustic signal to a digital token, wherein the second processing unit is connected to the acoustic sensor. In some implementations, the digital token contains a string of 4-bit integers and the acoustic signal contains a series of pitches, wherein the relationships between each 4-bit integer and each pitch are predefined in both the transmitting device and the camera device.

In accordance with some aspects of the present invention, the transmitting device is one selected from the group consisting of a computer, a smart TV, a mobile device, and a tablet; the acoustic wave generator is one selected from a group consisting of a speaker and an earphone; the acoustic wave sensor is one selected from a group consisting of a microphone, a surface acoustic wave filter, a surface acoustic wave resonator, and an acoustic sensor. In accordance with some other aspects of the present invention, the camera device may further comprises a network module, connected to the second processing unit, adapted to connect the camera device to a network, wherein the network module is one selected from a group consisting of a LAN transceiver, a WLAN transceiver, a cellular transceiver, a Bluetooth transceiver, an infrared transceiver, and a near field communication transceiver, and wherein the network is one selected from a group consisting of a LAN, a WLAN, a cellular network, a Bluetooth network, an infrared network, and a near field communication network. The digital token may, information for device pairing aside, further comprise user information, a MAC address, or a password needed for accessing the network.

In some embodiments, an operating method for camera device comprising: converting, by a first processing unit of a transmitting device, a string of 4-bit integers in a digital token to a series of pitches in an acoustic signal and transmitting the acoustic signal by an acoustic wave generator, wherein the first processing unit is connected to the acoustic wave generator; receiving, by an acoustic wave sensor of a camera device, the acoustic signal and transferring the acoustic signal to a second processing unit, wherein the acoustic sensor is connected to the second processing unit; converting, by the second processing unit, the acoustic signal to the digital token; and, utilizing, by the second processing unit, the digital token for device paring, authorizing, or authenticating.

In accordance with some aspects of the present invention, the operating method further contains an operating method of transmitting device and an operating method of camera device. The operating method of transmitting device may comprise: importing, by a transmitting device, a digital token; combining, by a first processing unit of the transmitting device, the digital token and a channel code to form a digital signal; dividing, by the first processing unit, the digital signal into a string of 4-bit integers; converting, by the first processing unit, the string of 4-bit integers to a series of pitches to form an acoustic signal, wherein the relationship of 16 different 4-bit integers and 16 different pitches are predefined in the camera system; inserting, by the first processing unit, a pattern into the acoustic signal, wherein the pattern is a sound with predetermined rhythm, frequency, or the combination thereof; transforming, by the first processing unit, the waveform and the amplitude of the acoustic signal; transferring, by the first processing unit, the acoustic signal to an acoustic wave generator; and, transmitting, by the acoustic wave generator, the acoustic wave generator via sound waves.

The operating method of camera device may comprise: sensing, by an acoustic wave sensor of a camera device, an acoustic signal; transferring, by the acoustic wave sensor, the acoustic signal to a second processing unit of the camera device; removing, by the second processing unit, noises in the acoustic signal; transforming, by the second processing unit, the acoustic signal with Fast Fourier transform (FFT); converting, by the second processing unit, the acoustic signal to a digital signal; determining, by the second processing unit, a reading frame of the digital signal; shifting, forwardly or backwardly by the second processing unit, the reading frame of the digital signal; retrieving, with the help of a channel code and by the second processing unit, a digital token from the digital signal; utilizing, by the second processing unit, the digital token for device pairing, authorizing, or authenticating between the camera device and the others.

In some embodiments, after the camera device and the transmitting device were paired, the operating method may further comprise: connecting, by a network module of the camera device, the camera device to a network, wherein the network module is connected to the second processing unit; and, transmitting, via the network, a message generated by the second processing unit. Since camera devices lack user interface or input interface to input information, in some embodiments, the digital token may further comprise data such as user information, a MAC address, or a password.

The camera system and operating method thereof in accordance with some embodiments provide a solution to overcome the drawbacks of wireless camera device; the camera system transmits a digital token via sound waves and uses the digital token for device pairing, authorizing, or authenticating; and, the camera device may further utilize user information, MAC addresses, or passwords contained in the digital token to access the network to transmit images, videos, audios captured by the camera device.

### BRIEF DESCRIPTION OF THE DRAWINGS

FIG. 1 is a schematic diagram illustrating a camera system in accordance with at least one embodiment of the present invention.

FIG. 2 is a detailed diagram illustrating a camera system in accordance with at least one embodiment of the present invention.

FIG. 3 is a flow diagram illustrating an operating method of camera system in accordance with at least one embodiment of the present invention.

FIG. 4 is a flow diagram illustrating an operating method of transmitting device in accordance with at least one embodiment of the present invention.

FIG. 5 is a flow diagram illustrating an operating method of camera device in accordance with at least one embodiment of the present invention.

### DESCRIPTION OF THE PREFERRED EMBODIMENTS

In a general aspect, at least one embodiment in accordance with the present invention provides a camera system and the operating method thereof. More particularly, at least one embodiment provides a camera system able to transmit a digital token via sound waves and the operating method thereof. The embodiments and drawings provided here show different aspects of the present invention. However, the present invention are neither limited to any embodiment nor drawing thereof.

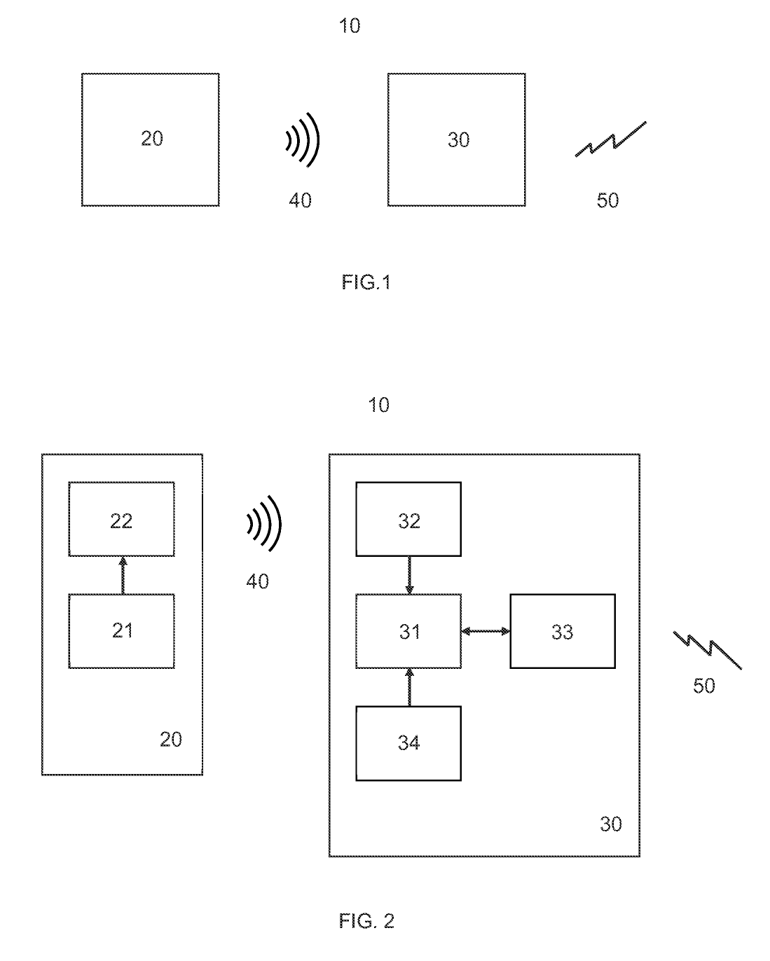

FIG. 1 is a schematic diagram illustrating a camera system in accordance with at least one embodiment of the present invention. In some aspects of FIG. 1, a camera system 10 comprises a transmitting device 20 and a camera device 30, wherein the transmitting device 20 and the camera device 30 are paired or authenticated via sound waves 40; furthermore, the transmitting device 20 may also enable the camera device 30 to access a network 50 via sound waves 40.

FIG. 2 is a detailed diagram illustrating a camera system in accordance with at least one embodiment of the present invention. In some aspects of FIG. 2, a camera system 10 comprises a transmitting device 20 and a camera device 30; the transmitting device 20 contains a first processing unit 21 adapted to convert a digital token to an acoustic signal and an acoustic wave generator 22 adapted to transmit the acoustic signal via sound waves 40, wherein the acoustic wave generator 22 is connected to the first processing unit 21, and wherein the digital token is used for device pairing, authorizing, or authenticating; the camera device 30 contains an acoustic wave sensor 32 adapted to sense the acoustic signal and a second processing unit 31 adapted to convert the acoustic signal to the digital token, wherein the second processing unit 31 is connected to the acoustic sensor 32.

In some other aspects of FIG. 2, the digital token contains a string of 4-bit integers and the acoustic signal contains a series of pitches, wherein the relationships between each 4-bit integer and each pitch are predefined in both the transmitting device 20 and the camera device 30. In these aspects, the transmitting device 20 may be one selected from the group consisting of a computer, a smart TV, a mobile device, and a tablet; the acoustic wave generator 22 may be one selected from a group consisting of a speaker and an earphone; the acoustic wave sensor 32 may be one selected from a group consisting of a microphone, a surface acoustic wave filter, a surface acoustic wave resonator, and an acoustic sensor; the digital token may, information for device pairing aside, further comprise user information, a MAC address, or a password needed for accessing a network 50.

In yet some other aspects of FIG. 2, the first processing unit 21 may also be adapted for: combining a digital token with a channel code, wherein the channel code is Reed-Solomon codes; inserting a pattern into the acoustic signal, wherein the pattern is a prefix pattern or a postfix pattern, and wherein the pattern is a sound with predetermined rhythm, frequency, or the combination thereof; or, transforming the waveform and the amplitude of the acoustic signal. In these aspects, the second processing unit 31 may be adapted for: removing noises in an acoustic signal; transforming the acoustic signal with FFT; converting the acoustic signal to a digital signal; determining a reading frame of the digital signal; forwardly or backwardly shifting the reading frame of the digital signal; retrieving a digital token from the digital signal with a channel code; utilizing the digital token for device pairing, authorizing, or authenticating between a camera device 30 and the others.

In still yet some other aspects of FIG. 2, a camera device 30 may further comprise a network module 33, connected to the second processing unit 31, adapted to connect the camera device 30 to a network 50; and, a camera 34, connected to the second processing unit 31, adapted to capture data of the environment. In these aspects, the network module 33 is one selected from a group consisting of a LAN transceiver, a WLAN transceiver, a cellular transceiver, a Bluetooth transceiver, an infrared transceiver, and a near field communication transceiver; and, the network 50 is one selected from a group consisting of a LAN, a WLAN, a cellular network, a Bluetooth network, an infrared network, and a near field communication network.

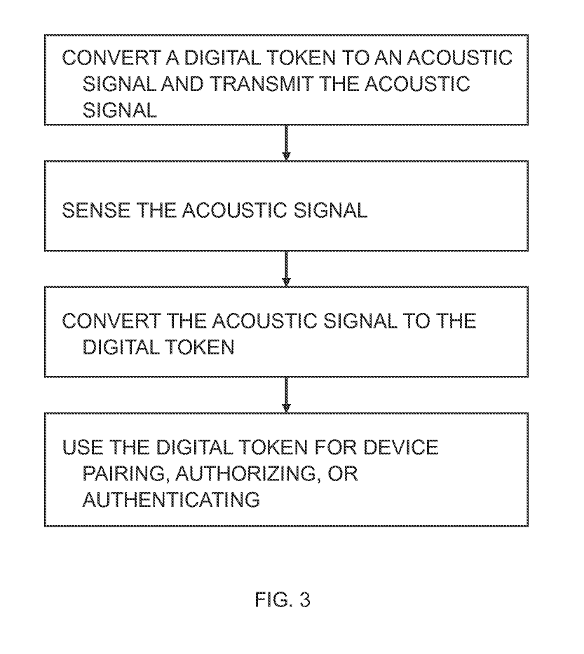

FIG. 3 is a flow diagram illustrating an operating method of camera system in accordance with at least one embodiment of the present invention. In some aspects of FIG. 3, the operating method of camera system 10 comprises: converting, by a first processing unit 21 of a transmitting device 20, a digital token to an acoustic signal and transmitting the acoustic signal by an acoustic wave generator 22; receiving, by an acoustic wave sensor 32 of a camera device 30, the acoustic signal and transferring the acoustic signal to a second processing unit 31; converting, by the second processing unit 31, the acoustic signal to the digital token; and, utilizing, by the second processing unit 31, the digital token for device paring, authorizing, or authenticating.

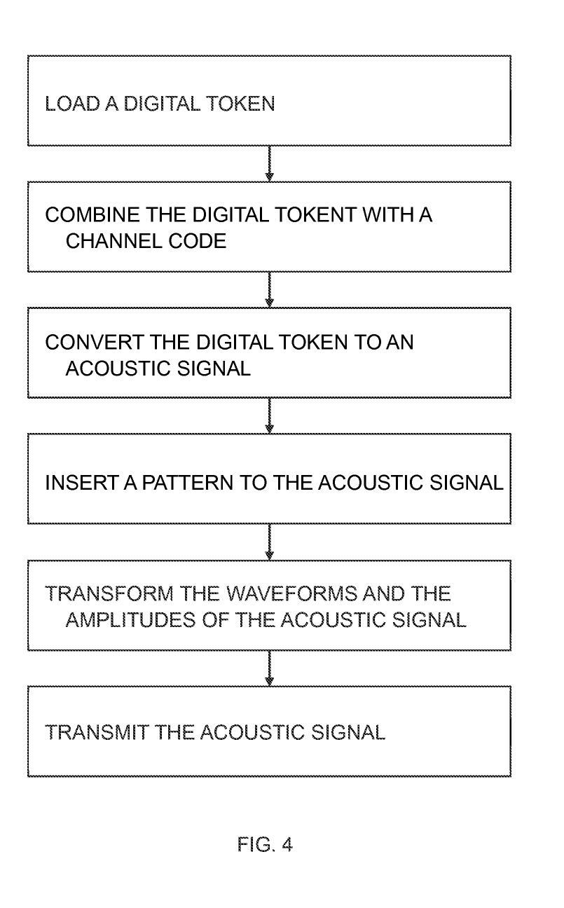

FIG. 4 is a flow diagram illustrating an operating method of transmitting device in accordance with at least one embodiment of the present invention. In some aspects of FIG. 4, the operating method of transmitting device 20 comprises: loading, by a first processing unit 21 of a transmitting device 20, a digital token; combining, by the first processing unit 21, the digital token and a channel code to form a digital signal; dividing, by the first processing unit 21, the digital signal into a string of 4-bit integers; converting, by the first processing unit 21, the string of 4-bit integers to a series of pitches to form an acoustic signal; inserting, by the first processing unit 21, a pattern into the acoustic signal; transforming, by the first processing unit 21, the waveform and the amplitude of the acoustic signal; transferring, by the first processing unit 21, the acoustic signal to an acoustic wave generator 22; and, transmitting, by the acoustic wave generator 22, the acoustic signal via sound waves 40.

In some other aspects of FIG. 4, a user may input or load a digital token by a mobile telephone, wherein the digital token comprises one selected from a group consisting of data for device pairing, user information, MAC addresses, passwords, and the combination thereof; a CPU of the mobile telephone combines the digital token and Reed-Solomon codes to form a digital signal; the CPU transforms the digital signal into a string of semi-octets; the CPU converts the string of semi-octets to a series of pitches to form an acoustic signal, wherein the relationship of 16 different semi-octets to 16 different pitches are predefined in the camera system 10; the CPU inserts a pattern into the acoustic signal, wherein the pattern is a sound with predetermined rhythm, frequency, or the combination thereof; the CPU transforms the waveform and the amplitude of each pitch of the acoustic signal, and transmits the acoustic signal via a speaker of the mobile telephone.

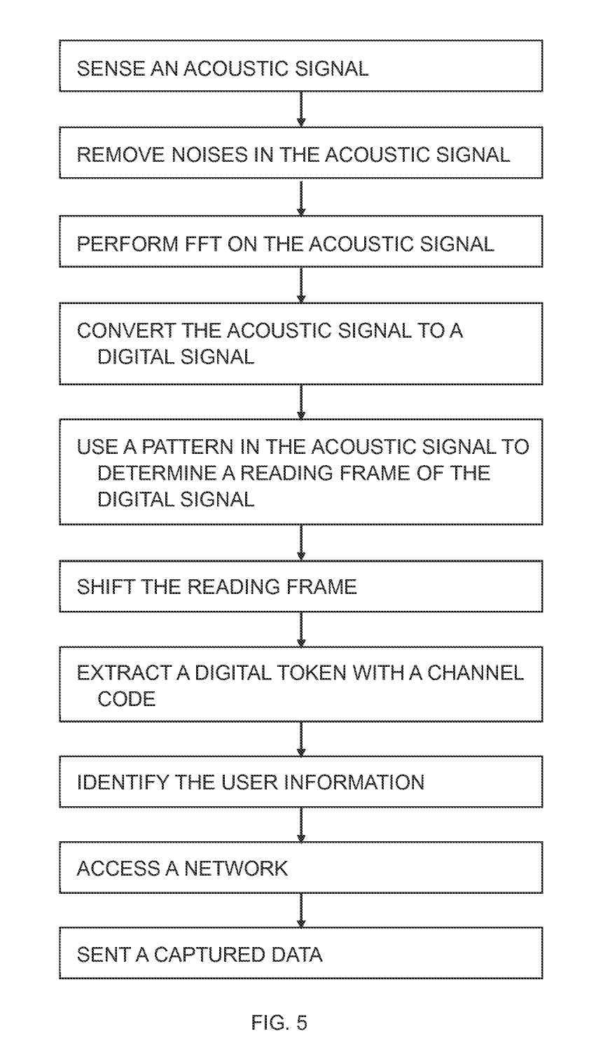

FIG. 5 is a flow diagram illustrating an operating method of camera device in accordance with at least one embodiment of the present invention. In some aspects of FIG. 5, the operating method of camera device 30 comprises: receiving, by an acoustic wave sensor 32 of a camera device 30, an acoustic signal; transferring, by the acoustic wave sensor 32, the acoustic signal to a second processing unit 31 for acoustic analysis; removing, by the second processing unit 31, environmental noises mixed in the acoustic signal; transforming, by the second processing unit 31, the acoustic signal with FFT; converting, by the second processing unit 31, a series of pitches of the acoustic signal to a string of 4-bit integers to form a digital signal; identifying, by the second processing unit 31, a reading frame in the string of 4-bit integers possibly containing a digital token; shifting, forwardly or backwardly by the second processing unit 31, the reading frame to neutralize a possible frameshift; retrieving, with the help of channel code and by the second processing unit 31, a digital token from the digital signal; utilizing, by the second processing unit 31, the digital token for device pairing, authorizing, or authenticating between the camera device 30 and the others; connecting, by a network module 33, the camera device 30 to a network 50; and, sending, via the network 50, a message generated by a camera 34 of the camera device 30.

In some other aspects of FIG. 5, a microphone of an IP camera senses an acoustic signal send from a mobile telephone and transfers the acoustic signal to a microchip of the IP camera for analysis; the microchip removes noises and echoes mixed from the environment with conventional de-reverberation and signal focusing means, wherein the de-reverberation and signal focusing means use techniques from open sources libraries and are not going to be further discussed in this section; an equalizer in the microchip transforms the waveform and the amplitude of the acoustic signal; the microchip performs FFT on the acoustic signal; the microchip converts a series of pitches of the acoustic signal to a string of semi-octets to form a digital signal, wherein each pitch is divided into multiple examining segments for multiple verifications during the pitch-to-integer conversion to enhance the accuracy; the microchip recognizes, with a pattern, a reading frame containing a digital token in the digital signal; the microchip shifts the reading frame in case of frameshift; and, the microchip retrieves the digital token from the digital signal with Reed-Solomon codes.

In these aspects, after the microchip retrieved the digital token from the digital signal, the microchip further utilizes the digital token to verify the identity of the mobile telephone and pair the mobile telephone with the IP camera; then, the IP camera connected to a Wi-Fi network via a Wi-Fi transceiver begins to stream captured images to the mobile telephone. In yet some other aspects of FIG. 5, wherein a Wi-Fi AP the IP camera attempts to access requires passwords or hides its SSID, the IP camera may further utilize a password or an AP MAC address carried in the digital token to log in to the Wi-Fi AP; or, in other cases wherein a user decides to watch the videos captured by the IP camera on a smart TV, the user may assign the smart TV to the IP camera by loading the MAC address of the smart TV into the digital token and delivering the digital token to the IP camera.

In still yet some other aspects of FIG. 5, wherein the database use for verifying the user information in the digital token is pre-stored in a remote service instead of the camera device 30. In these aspects, the microchip accesses the database in the remote service via the Wi-Fi network to verify the user information; and, the microchip performs verification of the identity of the mobile telephone and pair the mobile telephone with the IP camera.

What is claimed is:

1. A camera system comprising:
a transmitting device comprising:
a first processing unit adapted to convert a digital token to an acoustic signal, wherein the digital token is used for device paring, authorizing, or authenticating; and
an acoustic wave generator, connected to the first processing unit, adapted to transmit the acoustic signal;
a camera device comprising:
an acoustic wave sensor adapted to sense the acoustic signal; and
a second processing unit, connected to the acoustic sensor, adapted to convert the acoustic signal to the digital token;
wherein the digital token contains a string of 4-bit integers and the acoustic signal contains a series of pitches, and wherein the relationships between each 4-bit integer and each pitch are predefined in both the transmitting device and the camera device.

2. The camera system according to claim 1, wherein the transmitting device is one selected from the group consisting of a computer, a smart television (TV), a mobile device, and a tablet.

3. The camera system according to claim 1, wherein the acoustic wave generator is one selected from a group consisting of a speaker and an earphone.

4. The camera system according to claim 1, wherein the acoustic wave sensor is one selected from a group consisting of a microphone, a surface acoustic wave filter, a surface acoustic wave resonator, and an acoustic sensor.

5. The camera system according to claim 1, wherein the digital token comprises user information, a media access control (MAC) address, or a password.

6. The camera system according to claim 1, wherein the digital token comprises a channel code.

7. The camera system according to claim 1, wherein the acoustic signal comprises a pattern.

8. The camera system according to claim 7, wherein the pattern is a sound with predetermined rhythm, frequency, or the combination thereof.

9. The camera system according to claim 1, wherein the second processing unit comprises an equalizer.

10. The camera system according to claim 1, wherein the camera device comprises a network module, connected to the second processing unit, adapted to connect the camera device to a network.

11. The camera system according to claim 10, wherein the network module is one selected from a group consisting of a local area network (LAN) transceiver, a wireless local area network (WLAN) transceiver, a cellular transceiver, a Bluetooth transceiver, an infrared transceiver, and a near field communication transceiver.

12. The camera system according to claim 10, wherein the network is one selected from a group consisting of a local area network (LAN), a wireless local area network (WLAN), a cellular network, a Bluetooth network, an infrared network, and a near field communication network.

13. An operating method for a camera system comprising:
converting, by a first processing unit of a transmitting device, 4-bit integers in a digital token to pitches in an acoustic signal and transmitting the acoustic signal by an acoustic wave generator, wherein the first processing unit is connected to the acoustic wave generator;
receiving, by an acoustic wave sensor of a camera device, the acoustic signal and transferring the acoustic signal to a second processing unit, wherein the acoustic sensor is connected to the second processing unit;
converting, by the second processing unit, the acoustic signal to the digital token; and
utilizing, by the second processing unit, the digital token for device paring, authorizing, or authenticating.

14. The operating method according to claim 13, wherein the digital token comprises user information, a MAC address, or a password.

15. The operating method according to claim 13, wherein the digital token comprises a channel code.

16. The operating method according to claim 13, wherein the acoustic signal is inserted with a pattern.

17. The operating method according to claim 13, wherein the acoustic signal underwent waveform transformation or amplitude modulation before being transmitted by the acoustic wave generator.

18. The operating method according to claim 13, wherein the acoustic signal underwent transformation by an equalizer of the second processing unit when converting the acoustic signal to the digital token.

19. The operating method according to claim 16, wherein the second processing unit determines a reading frame by the pattern when converting the acoustic signal to the digital token.

20. The operating method according to claim 19, wherein the second processing unit shifts the reading frame when converting the acoustic signal to the digital token.

21. The operating method according to claim 15, wherein the second processing unit converts the acoustic signal to the digital token with the channel code.

22. The operating method according to claim 13, further comprises:
connecting, by a network module, the camera device to a network, wherein the network module is connected to the second processing unit; and
transmitting, via the network, a message generated by the second processing unit.
